(19) United States
(12) Patent Application Publication
(10) Pub. No.: US 2011/0089852 A1
(43) Pub. Date: Apr. 21, 2011

(54) Addressable LED Light String

(75) Inventor: Marc H. Segan, New York, NY (US)

(73) Assignee: M.H. SEGAN & COMPANY, INC., Long Island City, NY (US)

(21) Appl. No.: 12/991,885

(22) PCT Filed: May 11, 2009
(86) PCT No.: PCT/US2009/002946

§ 371 Date: Nov. 9, 2010

Related U.S. Application Data
(60) Provisional application No. 61/127,047, filed on May 9, 2008.

(51) Int. Cl. H05B 41/16; H05B 37/02; H02J 3/00

(52) U.S. Cl. 315/250; 315/312; 307/31

(57) ABSTRACT

An addressable light strand having a controller and a plurality of light modules, with a further plurality of lights. The control module includes a rectifier configured to provide the power output; and a control circuit configured to provide a data output. The plurality of light modules are connected in series. Each of the plural light modules has a zener diode that has an anode and a cathode, the anode is coupled to the power output of the control module and the cathode is coupled to an anode of a next serially connected light module. The light module also includes a semiconductor device having at least a power connection and a ground connection. The power connection is connected to the cathode of the zener diode and the ground connection is coupled to the anode of the zener diode.

### FIELD OF THE INVENTION

The present application claims priority from U.S. Provisional Patent Application 61/127,047, filed May 9, 2008, and incorporates herein the entire disclosure of the provisional patent application.

### BACKGROUND OF THE INVENTION

### Description of the Related Art

Originally created as a safer alternative to real candles on Christmas trees, electric Christmas lights have been made and sold for nearly 100 years. Small wattage line-voltage (120V AC) bulbs, wired in parallel, were originally the only type offered. The 1970's brought so-called mini-lights, low-wattage, low-voltage bulbs wired in series. These lights generated much less heat and are much smaller and less expensive than line-voltage bulbs. Over the years, mini-lights have become extremely inexpensive, almost to the point of the cost of the commodities involved—copper, plastic, glass—as their manufacture and sale ballooned. Indeed, strings of mini-lights have become virtually consumable.

To add value through product differentiation, manufacturers added various effects such as twinkling and sequencing. Thermal oscillators using the principle of a temperature sensitive bimetal contact, brought about the twinkling effect or, later, cause individual bulbs to blink on and off. As integrated circuits and especially one-chip microcontrollers fell in price, various blinking, dimming, chasing, and sequencing devices became practical and popular. Generally, these were made for use with mini-lights.

The advent of Light Emitting Diodes (LEDs) seemed to promise advances in Christmas lighting. The relative permanence, extremely long life, and low power consumption of LEDs were attractive features from the start. Until recent years, LEDs lack of brightness, paucity of colors (red only and then green), and relatively high cost made their use in holiday lighting rare.

More recently, technical developments have allowed LEDs to come into their own and market trends have cooperated in highlighting their advantages. Now LEDs come in many different colors, with far better brightness and much more affordable prices. With the higher cost of energy along with a generally heightened consumer and retailer sensitivity to environmental concerns, both energy efficiency and avoiding disposability makes LEDs more common and attractive for holiday lighting applications.

In fact, the unique characteristics of LEDs lead to new product possibilities. LEDs are inherently diodes, which means that they conduct current in only one direction. This creates new circuit opportunities and potential design efficiencies. LEDs are also extremely efficient, consuming very little current and producing very little heat. This allows LEDs to be driven with different kinds of circuits, potentially driven directly by the output ports of integrated circuits. The semiconductor, as opposed to incandescent, nature of LEDs means that they can be switched on and off with far greater rapidity than bulbs. This leads to possibilities for multiplexing to control brightness and color. Finally, LEDs practically never burn out. Therefore, a product employing LEDs can support somewhat more elaborate surrounding circuitry, since added cost will not be wasted on a product expected to be discarded after a single use.

Chasers and lighting sequencers allow blinking, twinkling, and brightness control of holiday lighting sets. In the last 20 years, these effects have been based on logic circuits and microprocessors to create various lighting effects. In holiday light strings, this has usually meant multiple light strings, often each containing bulbs of a single color, interwoven so that energizing them in timed sequences produces pleasing effects including the perception of lights in motion to a calibrated mixing of colors. Using three 50-light strings results in a 150-light chaser set. Employing microprocessors allows for elaborate chasing and fading effects, even using just three circuits.

Such a chaser set usually requires at least four wires: one for each series string of lights and one “common” line. This arrangement allows for individual control of three circuits, which is pleasing, but with a definite limitation on the range of possible effects. For example, one effect such a circuit cannot achieve may seem quite simple: a single energized light moving sequentially from one end of the light string to the other. To achieve this level of control would require one dedicated wire for every bulb, plus a return line, 151 wires in all. Absent an inventive leap, this degree of control has been heretofore impractical, extremely costly, and unwieldy. Nevertheless, its implications for decorative creativity are considerable.

### SUMMARY OF THE INVENTION

One goal of the invention is to achieve, economically and practically, individual timing and brightness control of each bulb in a holiday light string and related applications. This goal is achieved by taking advantage of the various benefits of LEDs and, in a first embodiment, using unique circuitry and commonly available components. The features of the invention could, in fact, be applied to strings of mini-lights as well.

A goal of the present invention is to reduce the number of wires in a string of lights while still achieving desired lighting effects. Three or four wires are typical in chaser light sets. More than four wires along the length of a light string becomes somewhat unwieldy, because of cost, unsightliness, and awkwardness of use. A thick wire harness is heavy and resists easy hanging, especially on a tree. Therefore, fewer wires running the length of the light strand is preferred.

The above-discussed light strands require a power supply. LEDs are very efficient devices, using as little as 10% of the power of a mini-light set of similar brightness. LEDs also operate on low-voltage, centering around 2 volts, depending upon color. A parallel wiring scheme works with a wiring bus distributing a low DC voltage along the string to power ICs and LEDs. However, this is not the preferred embodiment due to current demands and wire resistance.

A typical LED light strand is a series string. It therefore requires a relatively high voltage along the string, to allow for the sum of the drops over the entire string. This limits the size of the string due to the limits on the amount of the voltage available in conventional light strings.

Individual LEDs however, only require a small voltage drop, between approximately 1.5 and 3.5 volts. The LEDs may require a low voltage, but in order to introduce digital control of the LEDs, it would also be necessary to provide a low voltage source to operate the logic components, since logic ICs only require similar low voltage to operate. In parallel, the total current demand of 180 LEDs in a string at 20 mA requires a 3.6 amp power supply. Such a power supply would typically cost several dollars by itself, close to a prohibitive cost commercially for a string of decorative lights. Moreover, even relatively thick wire contributes a small amount of resistance per length. For example, 22 gauge copper wire is rated at 0.8 ohms per 50 feet and 26 gauge copper wire is rated at 2.4 ohms per 50 feet. This means that the average voltage drop at 2 amps across a 50 foot 1.6 ohm light string would be an inconsistent 3.2 volts, depending on how many lights are on. This amount of voltage swing presents considerable technical difficulties. IC performance and LED brightness would be unpredictable.

The disclosed addressable lighting system requires power and signal. For a parallel DC system a basic arrangement typically includes two wires for power, a positive line and ground, and two wires for data, data and a clock. There are various ways to combine data and clock signals into a single signal such as so-called self-clocking arrangements, which would reduce the wire count to three wires. In fact, such a signal can even be superimposed on a power line, as in powerline carrier systems to reduce the entire count to two wires. That would require a system to demodulate the combined signal as well as to decode the clock and data information.

The present system is a modular system that uses multiple substantially identical remote logic modules, each one of which controls multiple LEDs, using a connection scheme that requires a minimum number of interconnections. Preferably, in a shift-register version of the invention, there are only 3 wires running between modules, namely, a power line, a high-voltage return line, and a data line. In a more preferred embodiment using a microprocessor, only two lines are needed, the power lines serving triple-duty by providing data and clocking information as well as power.

The use of inexpensive modules to service multiple LEDs offers at least two major benefits, it saves cost, spreading the cost of the digital electronics across several lights, and it gathers multiple lights into a single electrical current node, efficiently matching the voltage and current needs of LEDs and driver ICs. It thereby allows the elimination of a central dc power supply, so that the system can work directly on line ac-power (current). The system is also highly flexible and expandable in various ways.

In one embodiment, brightness is controlled preferably from zero in gradations through full-on for each bulb or LED locally, meaning out along the light string. This typically implies at least one of logic and memory distributed along the string, in the form of an IC. One way to achieve this is by integrated circuit, either off-the-shelf or custom, that performs three functions: addressability (setting its individual state uniquely), local memory (preserving that state), and current drive (to control power to the bulbs or LEDs). In one embodiment, the IC is a common standard part such as a shift register or programmed microcontroller, both inexpensive and widely available. Further, the system is fast and smooth enough in performance to produce entertaining effects without noticeable flicker or discrete jumps in brightness.

### BRIEF DESCRIPTION OF THE DRAWINGS

In the drawing:

FIG. 1 is a diagram of a straight string of lights according to the invention;

FIG. 2 is a diagram of a string of icicle lights according to the invention;

FIG. 3 is a diagram of a string of lights according to the invention;

FIGS. 4a-4c are wiring diagrams for a string of lights according to the invention;

FIG. 5 is a schematic diagram of a control module for a string of lights according to an embodiment of the invention;

FIG. 6 is a schematic diagram of a light module for a string of lights according to an embodiment of the invention;

FIG. 7 is a schematic diagram of an end light module for a string of lights according to an embodiment of the invention;

FIG. 8 is a schematic diagram of a control module for a string of lights according to an embodiment of the invention; and

FIG. 9 is a schematic diagram of a light module for a string of lights according to an embodiment of the invention.

### DETAILED DESCRIPTION OF THE PRESENTLY PREFERRED EMBODIMENTS

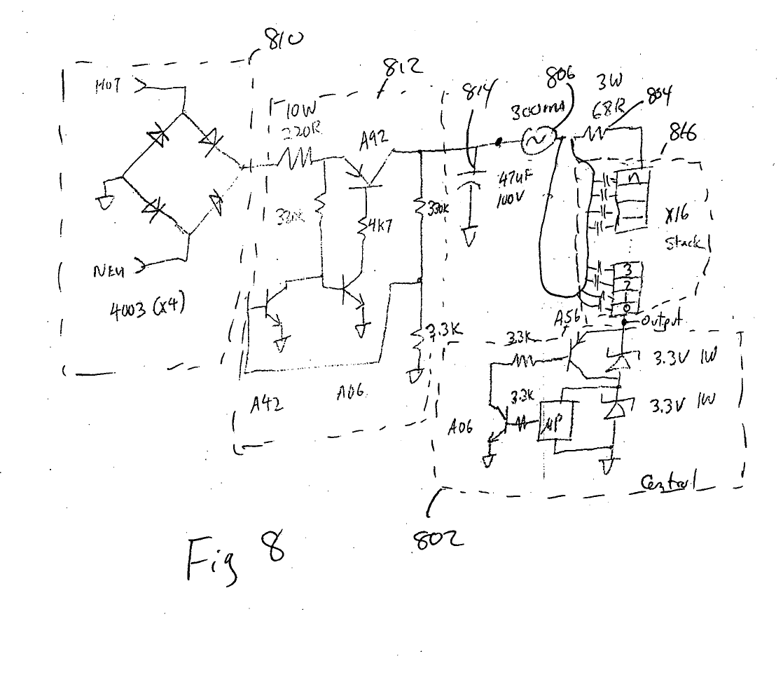

FIG. 8 is a control module according to the currently most preferred embodiment of the invention. As shown, there is a bridge rectifier 810 and a clipping circuit 812 formed by transistors A92, A42 and A06. In this preferred embodiment, the transistors are bipolar junction transistors (BJTs). The output of the clipping circuit is a sawtooth wave that is applied to a capacitor 814. A microprocessor control circuit 802 shifts the voltage to provide a clock signal as discussed below, and drive the lights that form the decorative display. The clock signal and driving signal are output on an output line 822.

Control circuit 802 also includes a microprocessor 816 in parallel with a first zener diode 818, and further includes a second zener diode 820 arranged as shown. The arrangements of zener diodes 818, 820 allows control circuit 802 to provide an appropriate voltage across each module 0-n via output line 822.

The output line 822 of control circuit 802 is applied to a stack 816 of modules 0-n, to drive the modules, and thereby drive individual lights (as discussed below). The highest voltage at the end of stack 816 is applied to a resistor 804 before passing through a return line 808. The return line 808 passes through the stack 816 to provide a reference voltage for modules 0-n so that modules 0-n may determine if a signal is being applied thereto.

The return line 808 is, in turn, applied to one end of a fuse 806, the other end of which is applied to the high voltage end of capacitor 814. The capacitor 814 is disposed between fuse 806 and clipping circuit 812, to provide means for storing power to drive the lights between cycles.

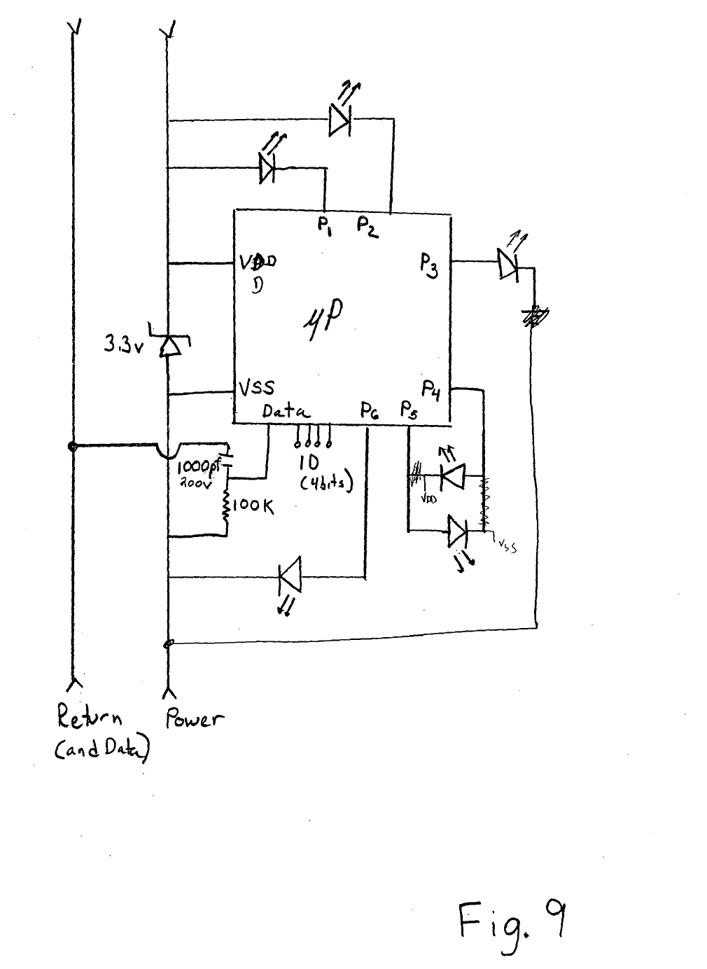

FIG. 9 is a schematic depiction of a light module according to a second embodiment of the invention. As shown, a microprocessor drives the LEDs. The return line is used for data. In a preferred embodiment, the microprocessor is an ESH series microprocessor sold by Elan. Typically, each of the modules is constructed on a printed circuit board or the like. In another embodiment, one or more LEDs are mounted on the printed circuit board containing the microprocessor. In one embodiment, all of the LEDs are connected to the microprocessor via wires. Using wires permits the LEDs to be spaced further from the microprocessor. Each of the microprocessors for a given module is programmable for example with a hard-wired ID using pads on the printed circuit board, jumper wires, or onboard memory. Each of the printed circuit boards can be the same and wire jumpers can either be soldered in or lines cut out to provide the ID. Alternatively, the 4 ID bits can be connected during manufacture in each of the 16 combinations. In one embodiment, all of the modules have the same ID and each module derives its individual address from its location in the string through communication with adjacent modules.

In one embodiment, the control module shown in FIG. 8 provides data to each of the modules so that each module runs a specific program. It should be noted that depending on the program being run, the module's position in the strand (i.e., first, second, etc.) affects the program.

Each of the LEDs can be two individual diodes or an LED diode pair. Further, given the low voltage requirements of the microprocessors, the zener diode may be a stacked 3.3-volt zener diodes for use with red LEDs or 5.1-volt zener diodes for white LEDs, depending upon the voltage requirements of the specific lights selected for the application.

In the microprocessor embodiment, brightness is controlled by duty cycle in known fashion.

In a preferred embodiment, outlets are included on the main control box or elsewhere on the string that will drive additional conventional LED light strings in synchronicity with the modular light set. In this manner, the physical size of the “effect show” is enlarged. Lacking individual light control features such as the shift register or microprocessor, such strings will cost less but they can be designed to work with this set and feature color arrangements that work with the shows built into the main string, which can be configured to anticipate the connection of the auxiliary set. In one embodiment, such auxiliary sets can include a microprocessor that controls a chaser arrangement much like conventional mini-light chasers, but in logical synchronization with the main light set.

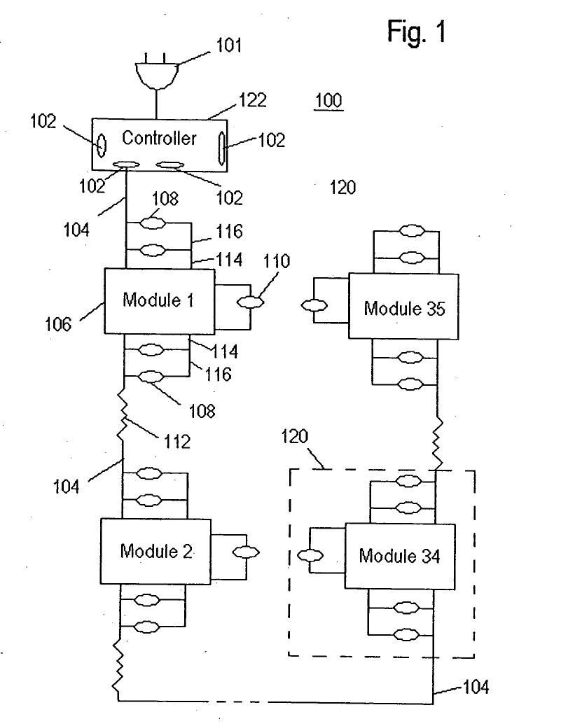

FIG. 1 depicts a second embodiment of the invention, and illustrates a straight string of electrical apparatus, such as lights 100 according to this embodiment of the invention. As shown, the light string 100 includes an AC plug 101, a controller 122, a plurality of modules 120, and a plurality of resistors 112. The controller 122 has a plurality of ports 102 for additional light strings. It will be appreciated by one of ordinary skill in the art that apparatus 100 could just as easily be loudspeakers having audio output, and/or motors for driving mechanical displays. One of ordinary skill in the art could choose the particular type of apparatus that suits any desired application as a matter of mere design choice. For ease of discussion, however, it will be assumed that all apparatus 100 are lights having only a visual output.

Each module 120 has a 3-wire input 104. The 3-wire input 104 provides power, return, and data. Between each module 120 in the string, there is a resistor 112 in one of the 3 wires 104. In operation, the resistor 112 is preferably in the data line.

Each of the modules 120 comprises a control module 106 and a plurality of LEDs 108. In a preferred embodiment, there are 5 or 6 LEDs per module. Further, each strand 100 includes 35 modules. Therefore, there are preferably 175 or 210 LEDs per strand. In one embodiment, so that there are 6 LEDs per module, LED 110 is two individual LEDs. Additionally, each of the LEDs 108 can be embodied as a multi-color LED or two oppositely biased LEDs. Within each module, wire 116 is a single wire and line 114 comprises 2 wires. Thus, while there are 5 wires in each strand reaching the nearest LED, there are only 3 wires between modules.

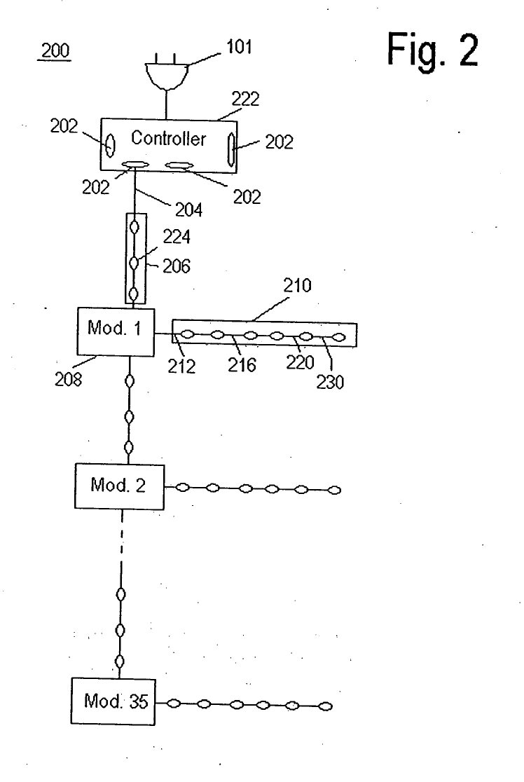

FIG. 2 is a wiring diagram for a string of “icicle lights” according to one embodiment of the invention. Icicle lights are a familiar physical layout of lights wherein multiple descending icicles interrupt a horizontal lights string. As shown, a controller 222 is connected to an AC source via plug 101. The controller 222 preferably has a plurality of ports 202 to which strands of icicle lights are connected. A first 4-wire line 204 leaves the controller 222 and includes a first set of lights 206 having three dimmable LEDs 224. A first module 208 has a string of icicle lights 210. In an embodiment there are 6 LEDs in the icicle 210. The number of wires leaving the module 208 diminishes between the first and last LED. Specifically, line 212 includes five wires, line 216 has four wires, line 220 has three wires and line 203 has two wires. In a preferred embodiment there are 35 modules such that there are 210 individually controllable LEDs. In one embodiment all of the sets of lights 206 in the individual modules are controlled simultaneously.

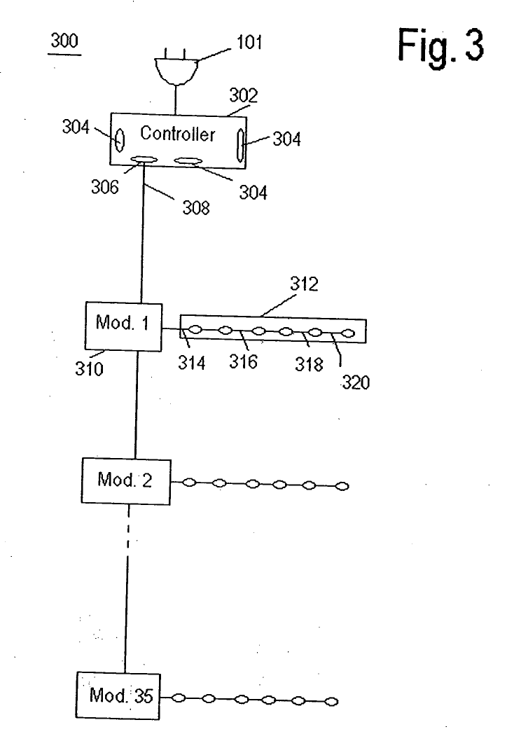

FIG. 3 is a diagram of a string of lights 300. As shown in FIG. 3, a controller 302 is connected to an AC source via plug 101. Controller 302 has a plurality of plugs 304. Each of the plugs 304 is typically a two-wire port for three additional strands. Alternatively, plugs 304 are multi-wire ports like port 306. In a preferred embodiment, the controller 302 does not include a transformer.

Port 306 is a 3 or 4 wire port. The 3 or 4 wires connect a plurality of modules 310 to the controller 302. In a preferred embodiment, there are 35 modules. Each module is attached to 1 or 2 identical six-light strings 312. Each of the six-light sets is the same. A first line 314 has 5 wires, line 316 has 4 wires, line 316 has 3 wires, and line 320 has 2 wires.

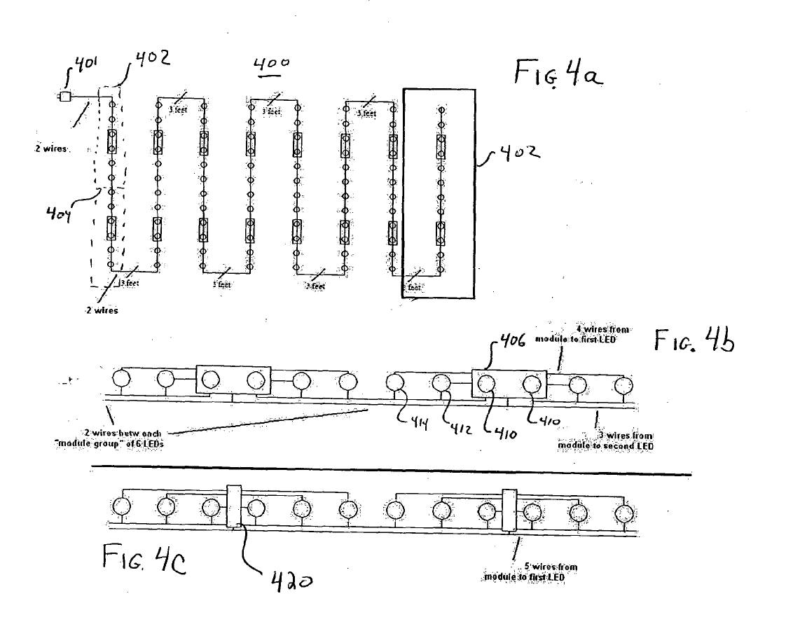

FIGS. 4A-4C depict a wiring diagram for a light strand. As shown in FIG. 4A, a 2-wire strand terminates in a plug 401. The light strand 400 has a plurality of lighting modules shown in detail in FIGS. 4B and 4C. Between each module 402, there is approximately 3 feet of wire. Each of these wiring sections connecting modules 402 is a 2-wire segment. It should be noted that in alternate embodiments, each module 402 could be separated at 404 to add extra length to the light strand.

FIG. 4B is a first embodiment of section 402 having a module 406 which includes 2 LEDs 410. LEDs 412 and 414 are spaced apart from the module 406. As the LEDs are spaced from the module 406 additional wires are required to connect them to the module 406. The farther the module is from the LED the fewer wires are present between the LED and the module. Including a grounding wire that runs substantially the entire length of the light string, there are three wires between LED 414 and module 406, and there are four wires between LED 412 and module 416. Between each group of 6 LEDs there are only two wires.

FIG. 4C shows a similar embodiment except that there are no LEDs as part of the module 420. As shown, each LED is individually wired. Therefore, in the embodiment shown in FIG. 4C there are additional wires present in each wired section.

Each of the modules discussed above are electrically wired in series. Thus, they are stacked with respect to voltage. Each of the modules operates on approximately 5 volts DC. This 5 volts is a differential from the input to the output of the stacked module. Each module is operating at a system potential that is 5 volts higher than the previous module. In the United States there is a peak available voltage of approximately 170 volts on an AC line. Allowing for reasonable headroom, approximately 30 modules can be accommodated on the single circuit. Each module has approximately 6 to 8 individual LEDs or 3 or 4 bidirectional multi color LEDs. Because of the series orientation of the modules, overall stack current is small enough that power loss due to wire resistance is not a concern. Preferably, a string of lights in accordance with the present disclosure will accommodate between 180 and 240 individual lights or LEDs and between 90 and 120 bidirectional lights or LEDs.

The light string is extendable by at least two different means. First, the same data stream is applied to an additional light strand that operates in logical parallel to the original strand. That second or further set would behave exactly like the first. The required connection would only involve data, clock and a common ground. Another method of extending the light strands involves the second light strand adding to the shift-register length, thus allowing for unique shows that maintain individual control over an even greater set of lights. The limit of this case would be the potentially lengthier data transfer interval. This concern can be overcome if the physical connection occurs at the control box and a second data set is output by the microcontroller specifically intended for a second or third light set.

A second IC could be implemented in each remote module, at least doubling the number of lights that can be controlled by each. Data, clock, power supply and OE circuits would be shared. The limitation would be the wiring arrangement, which under the existing one-chip design is somewhat optimized for a straightforward light string. Configurations like icicle lights and other formats may benefit from this form of extendibility.

In a further embodiment of the invention a circuit for reducing current consumption during darker periods is provided, thereby reducing overall energy use as well as permitting the set to automatically adjust for over-voltage situations or lower-than-normal-voltage situations (brown-out). The circuit involves the selection of different dropping (binarily related) resistors under microprocessor control. On the one hand, when the microprocessor “knows” that the required current is low it can switch in a higher-value (thus lower current) resistor set. On the other hand, when low line voltage is detected, it can switch in a lower resistance set to permit higher current from the lower voltage. Better performance and greater energy efficiency (less energy wasted as heat) are both achieved. Notably this type of circuit can be implemented even on simpler “non-smart” light sets.

In a light-string application, individual or groups of lights moving or “bouncing” along the length of the string can be accomplished for the first time. There are many related effects such as a “thermometer” growing its length or subgroups of moving lights. The shows are limited only by the imagination of the designers. For example, icicles can be realized where the icicles appear to be “growing” or dripping. Wired onto a pre-lit tree, all kinds of new effects are possible including “fireworks” shooting up from the center and falling downward, to a shimmering across the tree from one side to the other or bottom to top or vice-versa. Again, imagination is the only limitation. With the lights arranged geometrically, even a “signboard” can be implemented, showing animated images, chasing written messages and even a limited form of video. Many other physical arrangements of lights are easily imaginable, suggesting their own unique effects.

In one embodiment, the IC's clock is used instead of the output enable (OE) terminal to avoid the appearance of invalid data on the lights themselves. The use of OE has the disadvantage of wasting some small portion of available lighting power during the data interval. It has a corresponding advantage of allowing ports to cool and in conventional LED sets, lights go dark in any event for some period of time. Nonetheless, an alternative method of avoiding a blink of invalid data is the use of a strobe line instead of OE. Strobe would simply transfer the final shifted data set (when stable) to the output register which, until that moment, displayed the previous data set. This wastes no available lighting power because the outputs never go tri-state and, thus, dark. However, it also involves the use of an additional interconnection between modules, because the dual-use of the data line depends upon the outputs going tri-state.

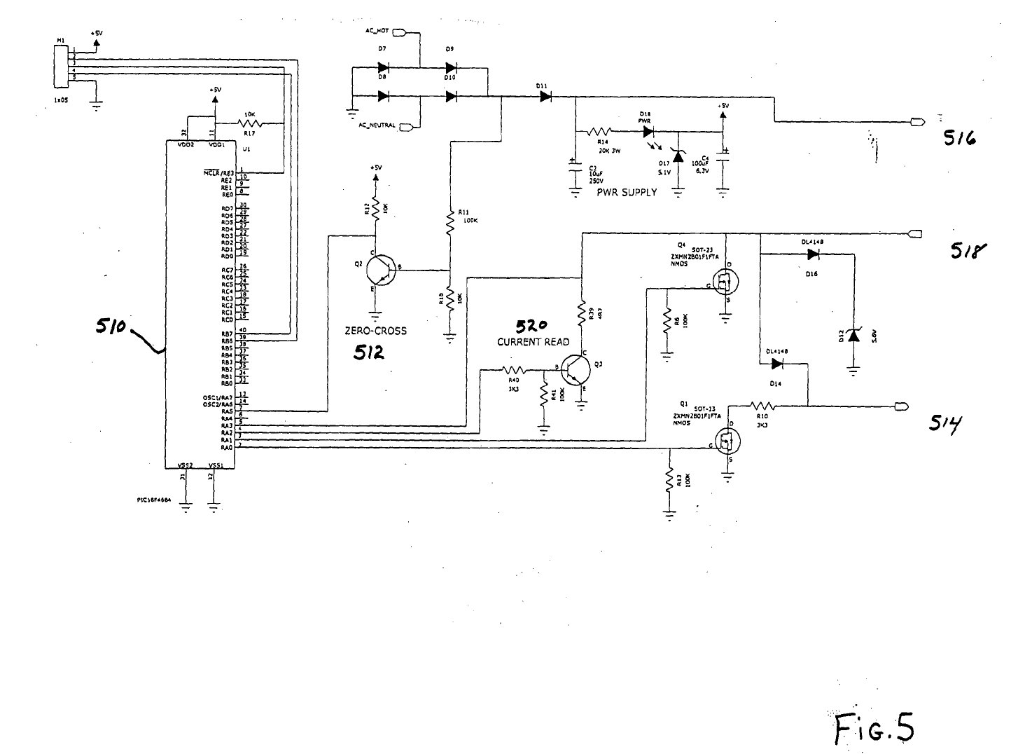

FIG. 5 is a schematic diagram of a control module according to a further embodiment of the invention. The power supply and control module is preferably a distributed transformerless power supply. A single bridge rectifier produces full wave power directly from the line voltage to all modules. In a preferred embodiment there is a single dropping resistor for the entire stack. Each of the modules uses a 5-volt zener diode to set its own operating voltage. The overall system appears as a full wave rectified signal filtered by a capacitor connected to the dropping resistor. In a preferred embodiment the bridge rectifier and capacitor are located in a control box whose schematic is generally shown in FIG. 5. The bridge rectifier comprises diodes D7-D10. A capacitor C2 may preferably be employed to maintain a constant voltage for the power supply of the light strands.

Using the circuitry shown in FIG. 5, current flow in the stack remains relatively constant. Thus, at each module when the LEDs are off or dim, drawing less current, each module's zener diode will draw more current, thus maintaining overall stack current.

The control module preferably includes a microprocessor 510. Additionally, there is a zero cross circuit 512 preferably implemented using a BJT which is part of the power supply capacitor charging circuit.

In a further embodiment, there are 3 outputs for the control module. The 3 outputs are the data line 514, return wire 516 and negative power wire 518.

The module of FIG. 5 is configured for zero-crossing synchronization. In full-wave rectification, every 8.3 milliseconds (the 60 Hz line frequency half-wave interval), the system voltage must fall below minimum operating voltage, indeed to zero. The present embodiment utilizes a hold-up capacitor that maintains the system voltage during those dropout periods. One variation involves minimizing the value of the hold-up capacitor, thus saving expense (since the capacitor is a high-voltage, relatively high-capacitance device). By energizing lighting only when the system voltage permits and using the drop-out period to shift data, a very low current is required. The manipulation of the dropping resistor, discussed above most likely plays a significant part in bringing about this approach. Its success depends on whether the LEDs are bright enough with the reduced time availability of power. In an extreme implementation of this approach, the big hold-up capacitor is eliminated and the shift-registers or microprocessors lose power during the dropout period, to regain it when the sine curve slopes upward again.

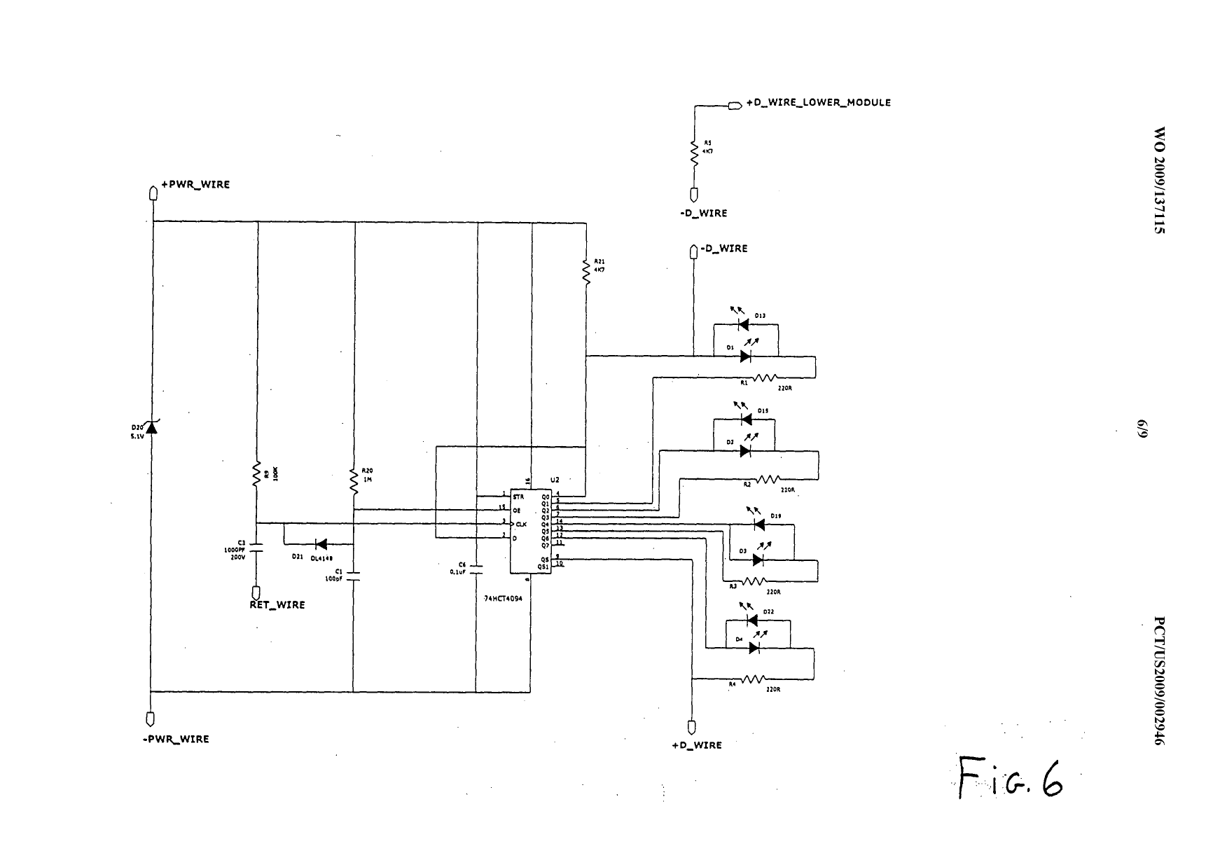

A standard light module is shown in FIG. 6. As shown, the module has a zener diode D20 that provides the 5-volt drop for each module. In a first embodiment, each module is constructed using commonly available components. Alternatively, an ASIC can be used to minimize components. In an embodiment, the IC is a 74HCT409 8-bit shift register. The output ports of HCT IC's are generally rated at 25 milliamps which is sufficient for direct drive of LEDs through a current limiting resistor for each of the LED pairs. A typical limiting resistor is 200 ohms. Because the 74HCT4094 is a shift register, data is serially provided via the D wire. In the preferred embodiment, there are 30 similar modules as shown in FIG. 6. The + power wire connects to the next modules − power wire and the +D wire connects to the higher modules −D wire. Each of the modules is connected to a return wire.

Because the modules are wired in series, the data associated with each individual LED is delivered in a series data format. No numerical addressing is required to deliver the correct data to each module. Rather, the lighting data is shifted down the serially connected shift registers until the correct number of bits is shifted in. Due to the serial shifting of the data, standard components can be used without losing any functionality.

As shown in FIG. 6, each output port of the 8-bit shift register is associated with a pair of directional single color LEDs or one single bidirectional 2 color LED. It should be noted that due to the serial connection of the modules, a 4.7 k resistor is added in series between each data line of the adjacent modules to correct for voltage differential between modules, thereby providing a logic-level shift.

A light string having the serially arranged modules is configured in a logical sense as a single 240 bit shift register. The microprocessor 510 in the control module inserts the data at the data in (+D wire) port of the first module at the low voltage end of the stack and data is synchronically clocked on a common clock single as discussed below. Because the modules are stacked and therefore have various relative voltages, a 4.7 k resistor is placed between the data output port of the lower module and the high impedance data input of the next module. In a preferred embodiment, the data wire for the shift register is used to illuminate a pair of LEDs. The physical position of the resistor between the modules is important. The high impedance data input lines of each shift register are connected directly to its own low-order light output. During the data transmission interval, all light-driver outputs are disabled and put into a high impedance state. The high impedance state is tri-state. The tri-state has no effect on the data stream and the data line can freely assume a logical 0 or 1. On the output side port QS's data does not go tri-state and always reflects the logic state of the shift registers Q7 high order bit, even when Q7 itself is tri-state. During the data transmission interval QS is sending data to the port it is connected to on the same module QS, which is in the light driving period and operates as an output light driver period. During that period, the QS and D lines must be relatively electrically isolated for the purpose of LED drive or the drivers will interfere. The relative electrical isolation is accomplished with the same 4.7 k resistor that during the data interval helps perform a logic level shift due to the varying voltages along the line of modules. In an embodiment, the microprocessor shifts one bit of data in approximately 3 microseconds. A total of 240 bits or the entire data transmission intervals lasts approximately 720 microseconds.

As shown in FIG. 6, the data line runs through each 4094° C. individually. Because all of the bits must be shifted simultaneously, the synchronizing CLK (clock) ports of the ICs must be strobed at the same time to move the data through the shift registers in synchronicity. A separate clock line or the complication of unpacking a data and clock combination data stream by employing the high-voltage return wire to carry the clock signal is not required given the circuit of FIG. 6. The clock is accomplished by shifting the voltage of the module stack by more than a logic level amount by the control module shown in FIG. 5. Using a fast-transitioning power MOSFET, the microprocessor switches a zener diode in and out of series with the bottom voltage of the stack. At the high-voltage end of the stack, a dropping resistor, preferably located in the central housing alongside the microprocessor and other central components, acts as a “rubber band” to accommodate the voltage shift of the whole stack. The return high-voltage line, which runs alongside every module, therefore, contains the common clock signal as a 150 to 155 volt level shift. Because each individual module operates at its own DC voltage supply level, a coupling capacitor extracts just the AC-coupled clock signal (and not the absolute DC level) for each IC's CLK port.

Additionally, in the embodiment of FIGS. 5 and 6 the output ports are disabled (tri-state) during the data transmission interval to avoid having shifting data appear on the lights. To accomplish this, each IC's Output Enable pin (OE) must be brought low. The OE pin is brought low using the AC-coupled clock signal to pulse an RC circuit pulling down OE long enough for the next clock pulse to occur, thereby recharging the RC once again. In this manner, OE stays low for almost precisely the length of the data transmission interval. This is important because during that interval lights are off, and therefore any electrical power otherwise available for illumination goes unused and wasted. This dark period has the side benefit of allowing the shift registers to cool if they have been overdriven to produce greater brightness. Brightness can be controlled by duty cycle.

It is worth noting that ordinary LED light strings wired in series and rectified blink off 60 or 120 times per second. The LEDs' fixed voltage drop will cause them to go dark when the rectified line voltage dips below a certain point. The duration of the LEDs' dark period will depend upon the supply voltage, the number of LEDs, and the LEDs' specific operating voltages.

A pair of ports of a given module's 4094° C., which controls two LEDs, are wired to drive the LEDs parallel and reverse to each other. Thus, when the pair of ports becomes logic 1, 0, one of the LEDs is energized and when the reverse occurs, 0, 1, the other LED lights are energized. When the ports are 1, 1 or 0, 0 or tri-state, both LEDs are dark. A pair of ports therefore drives a bi-directional LED, which is really a pair of LEDs within a single package. The two directions of drive are two phases of a light-driving sequence that offers each LED up to a maximum of close to 50% duty cycle or as a continuum of duty-cycle between the two colors of a single bi-directional LED pair.

In one embodiment, two different modes of dimming control are implemented. Both modes and their relationship flow logically and naturally from the implications of the structure of the invention.

For sequences involving multiple lights in motion, dimming control involves a revolving sequence of time-slices occurring fast enough to avoid discernable flicker. The time slices are proportioned binarily in a relation of 1, 2 and 4. In milliseconds, these can reasonably be approximately 2, 4 and 8 milliseconds, resulting in a total cycle time of 14 milliseconds and the three dark data shift intervals of 720 microseconds for a total of around 17 milliseconds or very close to 60 Hertz. In fact, these should be proportioned to precisely fit within the 60 Hz half-wave period. This timing allows the careful alignment of current usage with data transfer periods and light usage (maximum current usage) to allow minimization of filter capacitor usage, thus size and cost, for this high voltage capacitor. Within three fixed binary time-slices a total of 8 possible brightness levels are possible for each individual LED direction, including full off or dark, plus 12 different color combinations. If desired, additional color combinations can be added with additional time slices at the cost of additional dark time for data transfer. It should be noted that dimming every single light could be controlled individually with no logical interaction with any other light. The limit is that it involves 8 discrete levels of brightness (including off), which may appear jumpy with some effects.

The second dimming mode provides much finer control. Even maintaining the length of the time-slices for the purpose of software simplicity, the actual time that the LEDs are energized during a particular time-slice can be set at any arbitrary length of time, down to a few-microsecond resolution of the microprocessor's software. This means that even individual lights can be dimmed to a practically limitless degree of smoothness. This method of control applies to various subsets of lights as well. The limitation of this mode is that any LED using a particular time-slice is affected by the modification of the on time. Thus, effects that that use this mode will be more complicated to create and some combinations of brightness are logically impossible.

Between the two modes, dimming control is virtually limitless. To the extent that different colors of LEDs or bi-directional parts are employed, a wide range of color mixing is naturally achieved.

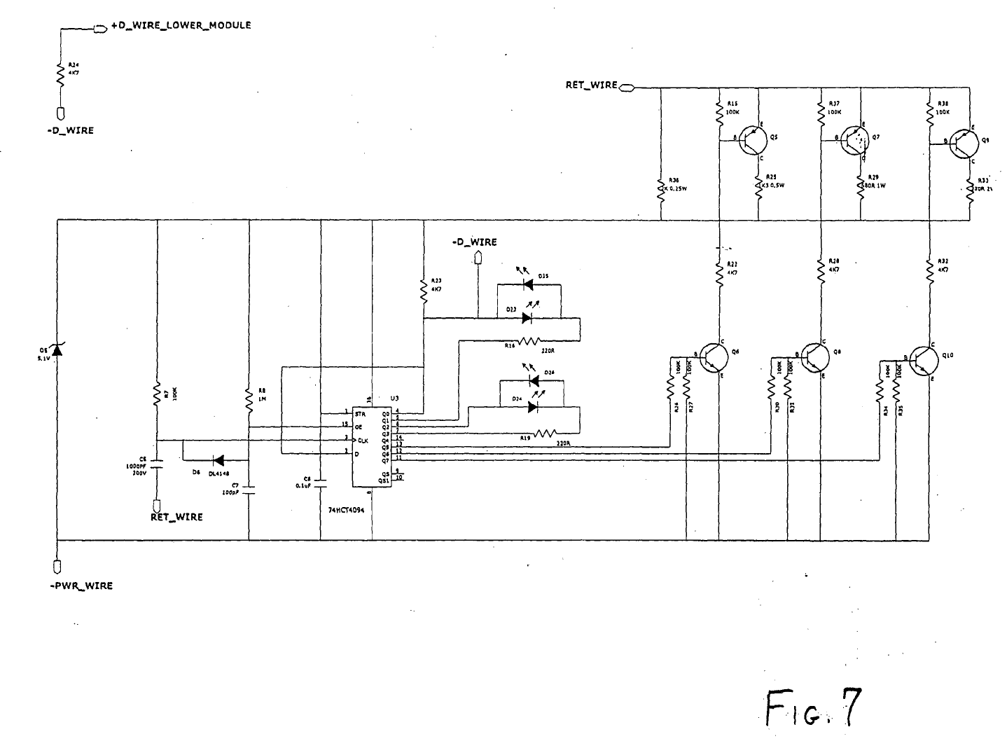

FIG. 7 is an end module according to the alternate embodiment of the invention. FIG. 7 is different than the other modules in that it does not connect to a next higher light module. The circuit shown in FIG. 7 has a zener diode D5 that provides the 5 volts for the shift register U3. However, because there are current and voltage loading considerations at the end of the light string, a transistor load is provided to account for the voltage and current variations.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps, which perform substantially the same function in substantially the same way to achieve the same results, are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A string of electronic apparatus comprising:
a controller;
means for receiving power from an outside source;
means for distributing power from said means for receiving power; and
first and second modules, each of said first and second modules including:
at least one individual unit of the string of electronic apparatus;
module power-receiving means for receiving power from said means for distributing power; and
a driver for driving said at least one unit;
wherein said controller includes module-control means for controlling said drivers.

2. The string of claim 1, wherein the power is ac-power.

3. The string of claim 1 wherein said controller further includes a selector for selecting a desired program from among a predetermined set of programs for driving said units in respective pre-determined patterns.

4. The string of claim 3, wherein said programs include at least two different sets of commands for driving individual ones of said units, whereby the string of electronic apparatus may provide different outputs for each of said sets of commands.

5. The string of claim 1, wherein said units are lights.

6. The string of claim 5, wherein said lights are light-emitting diodes.

7. The string of claim 1, wherein at least one of said units includes an audio output.

8. The string of claim 1, wherein at least one of said units includes a motor for moving a movable display in response to commands received from said controller.

9. The string of claim 1, wherein said drivers include means for turning said units “on” and “off”.

10. The string of claim 9, wherein said drivers includes means for controlling an intensity of said units when “on”.

11. The string of claim 10, wherein said intensity is a brightness of said unit.

12. The string of claim 1, wherein said module-control means includes means for generating a signal containing at least the following information:
an address of each of said units;
a command for action for each said unit; and
whereby said module-control means controls the sequencing and outputs of said units.

13. The string of claim 1, further comprising means for storing power received from said means for receiving power, and wherein said means for distributing power distributes power stored in said means for storing power.

14. The string of claim 13, wherein said means for storing power includes a capacitor.

15. The string of claim 1, wherein said means for distributing power includes a zener diode.

16. The string of claim 1, wherein said module-control means includes at least first and second shift registers associated, respectively, with said first and second modules.

17. The string of claim 1, wherein said controller outputs a stream of data to control said modules.

18. The string of claim 17, wherein said stream of data is overlaid on said power being distributed to said modules.

19. The string of claim 1, wherein said controller is separate from said first and second modules.

20. The string of claim 1, wherein said controller is distributed within said first and second modules.

21. The string of claim 20, wherein said first module includes means for identifying that it is said first module, and means for choosing, from among a group of commands provided to said first module, only those commands that are to be executed by said first module.

22. The string of claim 1, further comprising:
a return line running between said first and second modules; and
means for dissipating a signal voltage, said means for dissipating said signal voltage being disposed between said return line and said first and second modules.

23. The string of claim 22, further comprising means for dissipating excess power disposed between said return line and at least one of said first and second modules.

24. The string of claim 22, wherein said means for dissipating is a resistor.

25. A string of lights comprising:
a controller;
means for receiving ac power from a source of ac power;
a capacitor for storing power received from the source of ac power;
means for distributing power stored in said first capacitor;
a first module, including
a first plurality of lights;
a first module power-receiving means for receiving power distributed by said means for distributing power; and
a first driver for driving said first plurality of lights; and
a second module, including
a second plurality of lights;
a second module power-receiving means for receiving power distributed by said means for distributing power; and
a second driver for driving said second plurality of lights;
wherein said controller transmits a signal to said first and second modules to control said first and second plurality of lights.

26. The string of claim 25, wherein at least one of said first and second modules further includes at least one motor for driving a moving display, and said signal transmitted by said controller controls said at least one motor.

27. The string of claim 25, wherein at least one of said first and second modules further includes at least one audio output, and said signal transmitted by said controller controls said at least one audio output.

28. The string of claim 25, further comprising:
a line connecting said first and second modules; and
wherein said power and said signal are distributed along said line.

29. The string of claim 25 wherein said controller further includes a selector for selecting a desired program from among a predetermined set of programs for driving said lights in respective pre-determined patterns.

30. The string of claim 29, wherein said programs include at least two different sets of commands for driving individual ones of said lights, whereby the string of lights may provide different visual effects for each of said sets of commands.

31. The string of claim 30, wherein said signal includes information identifying which set of commands has been selected.

32. The string of claim 31, wherein said signal further includes information identifying a time sequence in said set of commands, to identify where in a sequence of said set of commands the current signal lies, so that each module will know what commands are to be executed.

33. The string of claim 32, wherein said first module includes means for receiving said information regarding said time sequence, and recognizing the position of said signal in said time sequence.

34. The string of claim 33, wherein said first module is pre-programmed to control said first plurality of lights in response to said signal, and said second module is pre-programmed to control said second plurality of lights in response to said second signal.

35. The string of claim 25, wherein said first module includes a first memory containing a first program responsive to said signal to drive said first plurality of lights in response to said signal.

36. The string of claim 35, wherein said second module includes a second memory containing a second program responsive to said signal to drive said second plurality of lights in response to said signal.

37. The string of claim 36, wherein said first and second programs each include data sufficient to drive both of said first and second pluralities of lights, and wherein said first module includes a first selector for selecting said first program to drive said first plurality of lights and said second module includes a second selector for selecting said second program to drive said second plurality of lights.

38. The string of claim 25, wherein said means for distributing includes a distributing zener diode.

39. The string of claim 38, wherein said first module includes a first module zener diode, and wherein said distributing zener diode and said first module zener diode cooperate to distribute power to said first module.

40. The string of claim 39, wherein said second module includes a second module zener diode, and wherein said distributing zener diode, said first module zener diode and said second module zener diode cooperate to distribute power to said first and second modules.

41. The string of claim 25, wherein at least one of said drivers includes means for controlling a brightness of at least one of said lights.

42. The string of claim 25, wherein at least one of said drivers includes means for controlling a color of at least one of said lights.

43. The string of claim 26, wherein at least one of said lights is a bi-directional light.

44. A string of lights comprising:
a controller;
means for receiving ac power from a source of ac power;
a capacitor for storing power received from the source of ac power;
means for distributing power stored in said first capacitor, including a distributing zener diode;
a first module, including
a first plurality of lights;
a first module power-receiving means for receiving power distributed by said means for distributing power, said first module power-receiving means including a first module zener diode; and
a first driver for driving said first plurality of lights; and
a second module, including
a second plurality of lights;
a second module power-receiving means for receiving power distributed by said means for distributing power, said second module power-receiving means including a second module zener diode; and
a second driver for driving said second plurality of lights;
wherein said controller transmits a signal to said first and second modules to control said first and second plurality of lights; and
wherein said controller further includes a selector for selecting from among a predetermined set of programs for driving said first and second pluralities of lights in different predetermined patterns and sequences.
